(19) United States
(12) Patent Application Publication
(10) Pub. No.: US 2012/0311525 A1
(43) Pub. Date: Dec. 6, 2012

(54) APPLICATION MANAGEMENT SYSTEM

(76) Inventors: Yann Xoual, Champigny-sur-Marne (FR); Marc Ciesla, Saint-Maur-Des-Fosses (FR)

(21) Appl. No.: 13/387,878

(22) PCT Filed: Jul. 30, 2010
(86) PCT No.: PCT/EP10/61133

§ 371 Date: Jul. 3, 2012

(30) Foreign Application Priority Data
Jul. 30, 2009 (FR) 0955352

(51) Int. Cl. G06F 9/44

(52) U.S. Cl. 717/104

(57) ABSTRACT

An application management system includes a web server including objects including a predefined and preassembled component, the objects forming: a generic organization model composed of logic organizational entities; a generic management model composed of logic operational entities; a generic control model composed of data analysis tools; a generic model of screens and kinematics for a user interface; a set of tables and files characterizing the activation and personalization options of the objects and the processes, streams and rules associated with the objects; tools for identifying possible activations of objects linked to an initial object activation; management tools for building logic networks including data spaces, and preassembled links that can be activated and personalized, each data space may be composed of all the objects, a connector object suitable for searching for tables and files; a data server including a single predefined physical database including data corresponding to the objects.

### TECHNICAL FIELD OF THE INVENTION

The present invention relates to an application management system.

### PRIOR ART

A known prior art for application management systems comprises a user interface to manage a plurality of applications, based on a plurality of application modules, said modules being based on a declarative computer programming language, for example in C++™ or JAVA™. For each application module, the user must declare, with said computer programming language, the attributes, functions, and links with other modules and events, that are associated with it. In general, these applications are present in the form of a software package dedicated to a predetermined recipient, for example the accountants in a company. Generic tools also exist that enable applications that also have a predetermined destination to be built.

A problem with this prior art is that the user is required to have technical computing knowledge to create and manage the application modules. In addition, the software packages are always dedicated to a specific recipient.

### OBJECT OF THE INVENTION

An object of the present invention is an application management system that enables the problem stated above to be resolved.

According to a first object of the invention, this object is reached by an application management system, characterized in that the system comprises:
objects comprising one or more predefined and preassembled components, said objects forming:
   a generic organization model composed of logic organizational entities suitable for being linked to one another;
   a generic management model composed of logic operational entities suitable for being linked to one another;
   a generic control module composed of data analysis tools;
   a generic model of screens and kinematics for a user interface;
a single predefined physical database comprising data corresponding to said objects;
a set of tables and files characterizing the activation and personalization options of the objects and characterizing the processes, streams and rules associated with the objects;
tools for identifying possible object activations linked to an initial object activation;
management tools for building logic networks comprising data spaces, and preassembled links that can be activated and personalized, each data space may be composed of all the objects, said network being integrated in the single physical database;
a connector object implementing the generic models, the database, the set of tables and files, said identification and management tools;
and in that said method provides applications:
that are instances of the application management system, one instance representing a specific activation set and a specific personalization set;
which vary over consecutive versions thanks to extensions of said instances based on the application management system, such as to represent software packages;
in which the screens are generated every time the user is prompted via the user interface;
and in that the application management system as well as the resulting applications operate entirely on a server that can be accessed via an Internet browser.

According to non-limiting modes of embodiment, the application management system may also comprise one or more additional characteristics from among the following:
An operational and/or organizational entity and/or an analysis tool is suitable for being uniquely referenced while being utilized in several data spaces. This enables a transverse utilization of an operational entity, organizational entity, analysis tool in several data spaces.
The cross-referencing is selective according to a criteria activation set. This enables the entities and tools to be “propagated” in the data spaces, to define the activation and personalization set by space.

This optimizes and simplifies the management of shared data.
The application management system comprises means to verify the consistency in real time between objects when an object is activated. This enables the consistency of data in the system to be maintained.
An application may use several data spaces and conversely one data space may contain several applications. This enables a high flexibility in the urbanization of an application, from the simplest to the most complex. The evolution of an application is much more easily managed by adapting the distribution of entities in spaces and the choices of an activation set.
The application management system comprises a generic import/export device of components of said entities defined by filtering to external data management systems suitable for cooperating with the application management system so as to generate a generic stream that is created with the activation and personalization sets.

This enables data chosen at the administrator level to be displayed by parameterization in a given format that is a function of the external data management systems.
The application management system comprises a free parameterization device of new components in an entity. This enables an entity to be changed.
The application management system comprises a common data space, in that a data space is suitable for inheriting components from organizational and operational entities of said common data space.

This enables certain entity components and fields to be defined once and for all if necessary. Therefore, there is a savings in terms of application creation and administration costs.
The common data space itself inherits an initial instance created by default when the connector object is launched. This enables the system to operate by mitigating failures or parameterization inconsistencies by itself.
The application management system comprises an accreditation device comprising:
   A plurality of first accreditation levels attributable to an intervening unit from an organizational entity;
   A plurality of rights attributable to actions suitable for being performed by an intervening unit;
   A plurality of second accreditation levels attributable to at least one user profile with which the intervening units are associated;
   Said first and second accreditation levels and said plurality of rights being suitable for being combined with each other.

The accreditation levels enable the rights enabling certain actions to be performed or not to be placed at different levels in an organizational entity. The combination of both enables a flexible attribution of accreditations and rights.
The accreditation device is suitable for attributing a right on actions associated with a data space, entity or component.

This enables having an expert application of accreditation levels and rights.
A data space inherits accreditations and rights attributed to the common data space according to a role attributed to an intervening unit of an organizational entity.

Depending on the organizational entity, this enables all or part of the rights of a common space to be inherited.
The application management system comprises a device to access operational entity components according to the state of progress of the operational entity and a role attributed to an intervening unit of an organizational entity, the state of progress being suitable for being applied to several spaces by respecting the different instances. This enables modification of a component by an intervening unit to be blocked if a state is not terminated, for example. Therefore, this enables the advancement of an operational entity, such as a request, to be controlled. Multi-space management enables enhanced management of the accessibility device.
The application management system comprises a duplication device of an original operational entity suitable for utilizing a redefinition unit of components from the duplicated operational entity with relation to the original operational entity.

This enables an operational entity to be copied several times while retaining flexibility in the definition of the new copied entity.
The application management system comprises a rule definition base associated with components of an entity so as to verify the real time consistency of a screen.

This enables the rules of use to be set forth in a managed application such as, for example, the automatic change of a step in the life cycle of an operational entity such as a “Request” entity.
The application management system comprises a hierarchy of levels associated with operational entities in which:
   A first-level operational entity is suitable for being directly connected to an organizational entity;
   A second-level operational entity is suitable for being directly connected to a first-level operational entity or to an organizational entity; and
   A third-level operational entity is suitable for being directly connected to a second-level operational entity or to an organizational entity.

This enables cross-referencing from several levels between entities. The management of an application is therefore more flexible.
An operational entity of a level below the first level is also suitable for being directly connected to another operational entity of the same level; each level of a space may be connected to each level of another space.

This enables cross-referencing from several levels between entities of the same type. The management of an application is therefore more flexible. Multi-space management enables hierarchy couplings and therefore coupling between several different and personalized entities.
The application management system also comprises a second device for activating a parameterizable processing procedure according to a type of operational entity. This enables, at the level of an operational entity, the passages from one process to another to be determined, one process comprising a plurality of steps and functions.

The invention and its various applications will be better understood upon reading the following description and examining the accompanying figures.

### BRIEF DESCRIPTION OF THE FIGURES

The figures are presented for indicative purposes and in no way limit the invention.

FIG. 1a schematically represents a server comprising the application management system comprising a single data base, and an Internet browser by means of which a user accesses the application management system according to the invention;

FIG. 1b schematically represents the application management system according to a non-limiting mode of embodiment of the invention;

FIG. 2 schematically represents a meta-model provided by the application management system of FIG. 1b comprising a generic organizational model, a generic management model, a generic control model and a generic model of screens and kinematics;

FIG. 3 schematically represents a connector object of the application management system of FIG. 1b implementing the generic models, the data base, tables and files characterizing the activation and personalization options of the objects and characterizing the processes, streams and rules associated with the objects;

FIG. 4 represents the management tools of the application management system of FIG. 1b enabling the building of logic networks comprising data spaces, and an example of data spaces;

FIG. 5 schematically represents a distribution of generic models from FIG. 2 per data space;

FIG. 6 is a simplified representation of a non-limiting mode of embodiment of the application management system according to the invention;

FIG. 7 is a simplified diagram of a group of tables utilized by the application management system of FIG. 6 according to a non-limiting mode of embodiment;

FIG. 8 is a simplified diagram of a plurality of data spaces, from an organizational entity and from several operational entities, said spaces being associated with an application according to a non-limiting example managed by the application management system of FIG. 6;

FIG. 9 is a detailed diagram of a first data space of FIG. 8 according to a non-limiting example;

FIG. 10 is a detailed diagram of a second data space of FIG. 8 according to a non-limiting example;

FIG. 11 is a simplified diagram of a group of tables utilized by the application management system of FIG. 6 in the context of the application taken as a non-limiting example of FIG. 8; and

FIG. 12 is a simplified diagram of a non-limiting example of an accreditation device comprising a table of accreditations and rights, said device being comprised in the application management system of FIG. 6.

### DETAILED DESCRIPTION OF THE INVENTION

In all figures, common elements bear the same reference numbers.

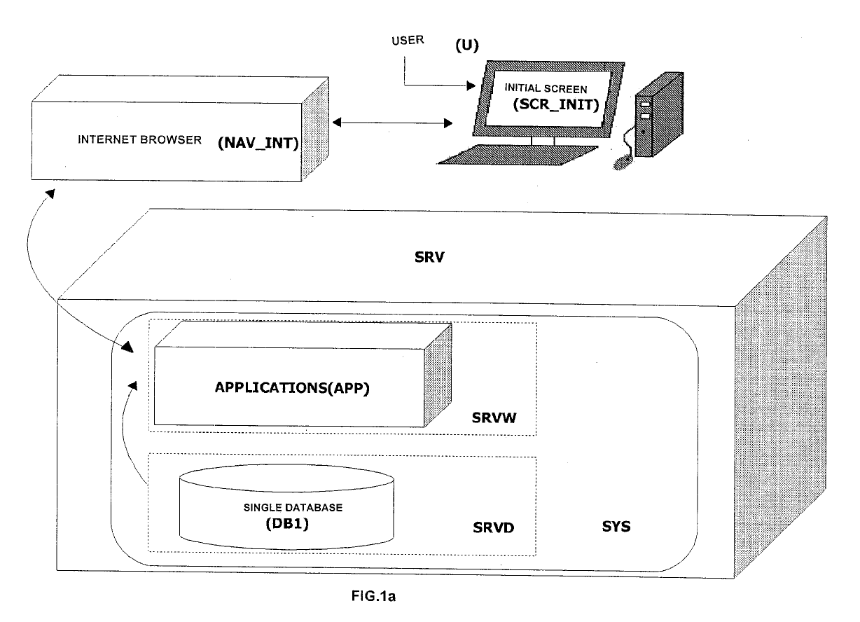

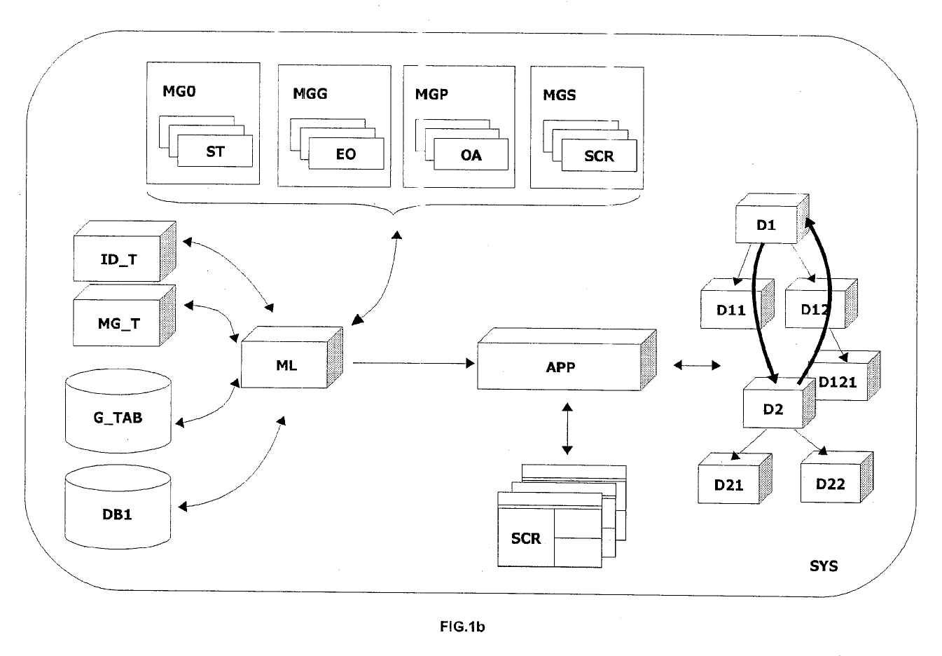

The application management system SYS according to the invention is described in a non-limiting mode of embodiment in FIG. 1a, FIG. 1b to FIG. 6.

It will be noted that application management is understood to refer to the creation, administration and utilization of applications.

According to a non-limiting mode of embodiment, the application management system SYS comprises, as illustrated in FIG. 1b:
objects comprising one or more predefined and preassembled components Cp, said objects forming:
   a generic organization model MGO composed of logic organizational entities ST suitable for being linked to one another;
   a generic management model MGG composed of logic operational entities EO suitable for being linked to one another;
   a generic control model MGP composed of data analysis tools OA;
   a generic model MGS of screens and kinematics SCR for a user interface UI;
a single predefined physical database DB1 comprising data corresponding to said objects;
a set of tables and files G_TAB characterizing the activation and personalization options of the objects and characterizing the processes, streams and rules associated with the objects;
tools ID_T for identifying possible object activations linked to an initial object activation;
management tools MG_T for building logic networks comprising data spaces, and preassembled links that can be activated and personalized, each data space may be composed of all the objects, said network being integrated in the single physical database;
a connector object ML implementing the generic models, the database, the set of tables and files, said identification and management tools;
and in that said method provides applications APP;
that are instances of the application management system SYS, one instance INST representing a specific activation set and a specific personalization set;
which vary over consecutive versions Ver thanks to extensions of said instances INST based on the application management system SYS, so as to represent software packages;
in which the screens SCR are generated every time the user is prompted via the user interface UI;
and in that the application management system SYS as well as the resulting applications APP operate entirely on a server SRV that can be accessed via an Internet browser NAV_INT.

Pre-assembly is understood to refer to the act of activating the links between generic objects.

Predefined is understood to refer to the fact that the data base is created and therefore exists before the creation of any application whatsoever. It comprises all of the data zones that may be displayed on the screens SCR.

Kinematics is understood to refer to the sequencing of screens SCR.

As may be seen in FIG. 1a, a server SRV comprises the application system SYS and the applications that it provides. A user U has access to the application management system via the Internet browser NAV_INT.

Thus, in practice such as illustrated in FIG. 1a, on the client side, there is the Internet browser (more specifically, a web browser), and on the server side SRV, there is:
a web server SRVW comprising the generic models, all of the tables and files, the identification and management tools and a connector object ML; and
a data server SRVD comprising the single physical data base DB1.

It will be noted that the connector object ML is formed of software means and the software means comprise at least one computer program product.

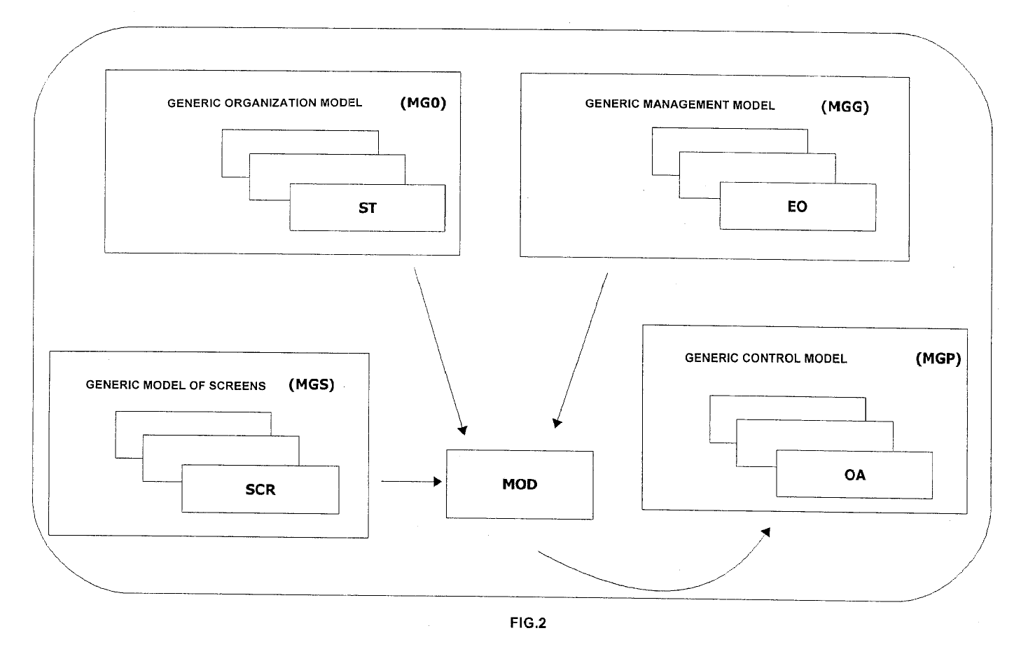

As may be seen in FIG. 2, the generic organization model MGO, the generic management model MGG, the generic control model MGP and the generic model MGS of screens and kinematics SCR compose a generic model MOD, also called a meta-model.

The generic organization model MGO is composed of logic organizational entities ST suitable for being linked to one another and is described below.

The generic management model MGG is composed of logic operational entities EO suitable for being linked to one another and is described below. The generic control model MGP is composed of data analysis tools OA described below.

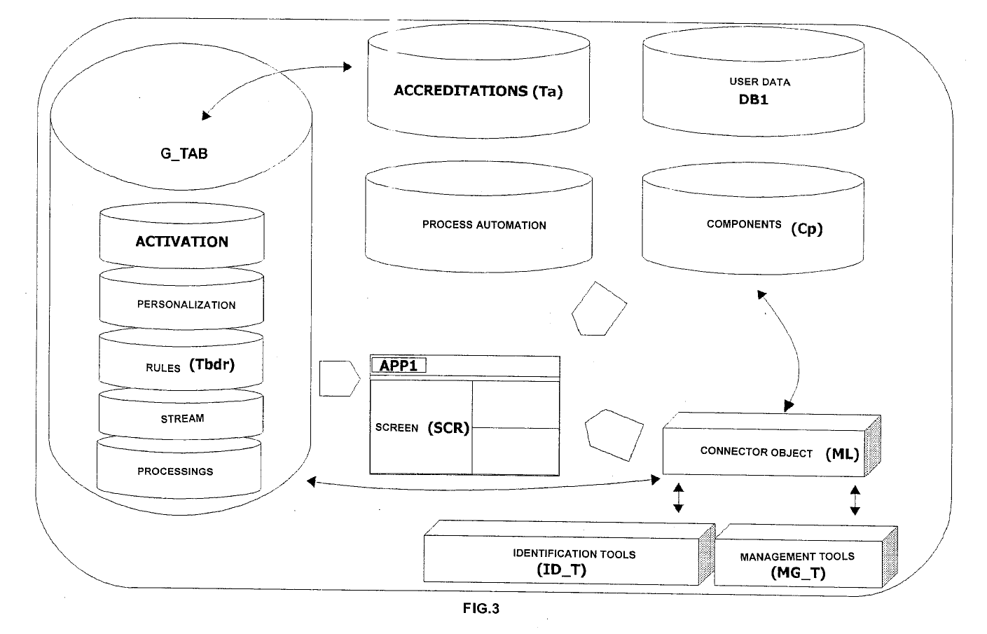

As may be seen in FIG. 3, the connector object ML implements the generic models MOD, the data base DB1, the set of tables and files G_TAB, and said identification ID_T and management MG_T tools. In addition, the connector object ML implements an accreditation device Ta (described below), object components Cp and automated processes (called “workflow”).

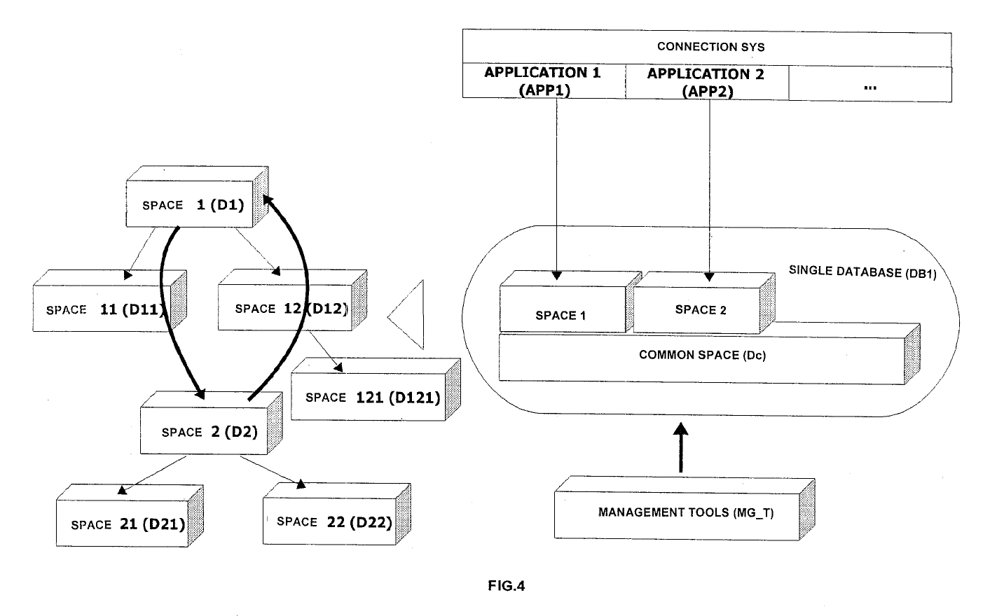

As may be seen in FIG. 4, management tools MG_T enable the distribution of applications by data spaces D, i.e., the creation of one or more data spaces per application APP.

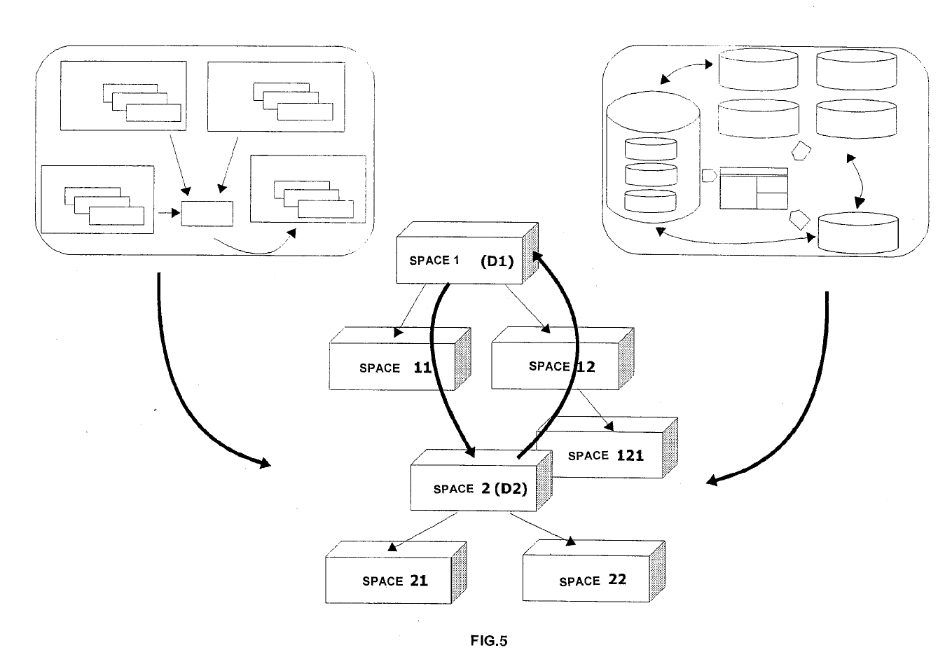

Lastly, as may be seen in FIG. 5, the generic models of FIG. 2, the data of objects are distributed per data space, as explained below.

According to a non-limiting mode of embodiment, the application management system SYS comprises at least one data space D suitable for being associated with an application APP, said data space D comprising:
At least one organizational entity ST suitable for being referenced in at least one other data space D and comprising a plurality of first components Cp1;
At least one operational entity EO comprising a plurality of second components Cp2;
   the first and second components Cp1, Cp2 being suitable for being activated/deactivated by parameterization within said data space D according to the managed application.

In a non-limiting mode of embodiment, an operational entity EO and/or an organizational entity ST and/or an analysis tool OA is suitable for being uniquely referenced while being utilized in several data spaces D. One may therefore manage the same persons for example on different applications.

In a non-limiting mode of embodiment, the cross-referencing is selective according to a set of criteria (not represented in the figures). It is possible to see a same organization with the same persons according to the allocation criteria at each space, data activation or not, personalization of data and rights of access and management at the level of each datum.

In a non-limiting mode of embodiment, a plurality of data spaces D are suitable for being associated with an application.

It will be noted that the application management system SYS is suitable for being utilized by users to create, administer and utilize applications APP.

Therefore, a first-level user U1 that we will also name administrator user will be able to create, administer and utilize an application APP, while a second-level user U2 that we will name final user will be able to utilize an application APP.

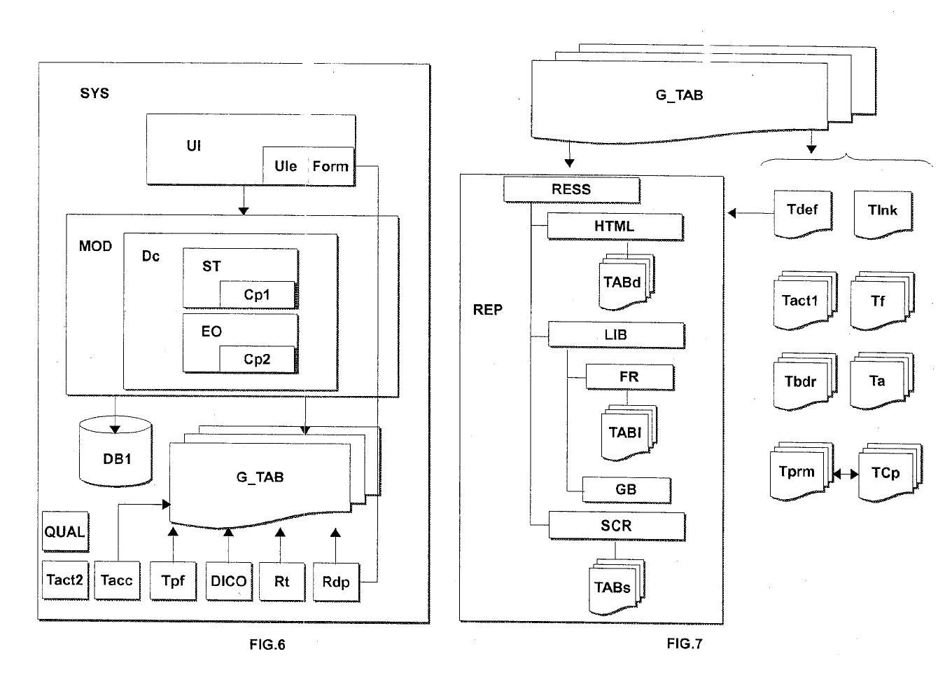

As illustrated in FIG. 6, the application management system SYS also comprises a user interface UI suitable for enabling the creation, administration and utilization of an application APP by a user U1 or U2.

The user interface UI is based on a logic model MOD comprising the plurality of objects (data space, organizational entity, operational entity, components described below), Said objects being defined in the tables, for example in text or XML format, as will be seen below, and the results of the utilization (inputting, calculations, etc.) Of the application APP being registered in a same single physical database DB1.

Therefore, as will be seen, the act of utilizing simple tables TAB that do not utilize any programming language saves any user, whether an administrator user or final user, from developing a single line of code or even from needing computer knowledge to declare the objects of the chosen application. Thanks to these tables that will, in particular, enable an object to be activated/deactivated by parameterization within a same data space D, a user will be able to simply create, administer and utilize an application APP.

In a non-limiting mode of embodiment illustrated in FIG. 6, the application management system SYS therefore comprises a group of tables G_TAB that enable the definition of:
at least one data space D suitable for being associated with an application APP, said data space D comprising:
   At least one organizational entity ST suitable for being referenced in at least one other data space D and comprising a plurality of first components Cp1;
   At least one operational entity EO comprising a plurality of second components Cp2.

The group of tables G_TAB enables a user to define the aforementioned objects according to the application APP chosen.

In a non-limiting example of embodiment, the tables TAB of the group of tables G_TAB are distributed in a system of files REP structured in the following manner such as illustrated in FIG. 7:
A resource directory RESS comprising:
   A first subdirectory of the first level of the texts LIB comprising tables TABI relative to the different texts of the objects of the application;
   First subdirectories of the second level of language FR, GB, etc., relative to the language used in the application;
   A second subdirectory of the first level screen SCR comprising tables TABs relative to the different screens of objects of the application and in particular to the different components of these screens;
   A third subdirectory HTML design comprising the tables TABd relative to the design elements utilized for a data space D, such as the font used in the screens, the color, the location of components, etc.

These directories are used for the personalization of objects per space. This personalization may be managed by any administrator user without any particular technical knowledge.

Data space D is understood to refer to a logical grouping of objects that are logically linked to each other by a set of rights and attributions, actions, display rules and common parameterizations. The common parameterization enables the presence and conditions of use of objects of a data space D to be defined.

In other words, as will be seen in detail below, a data space D corresponds to a set of parameterizations:
by activation of: components enabling the definition of tabs, fields, lists, etc. representative of screens of an application, summary tables, etc.
by personalization of texts
accreditations, rights R, role Ro.

Organizational entity ST is understood to refer to an entity (corporation, corporation department, etc.) Representative of a plurality of intervening units ITV (private individuals). An organizational entity ST enables the definition of which intervening units are accessible by an operational entity EO.

An organizational entity ST may be hierarchical. Therefore, in a non-limiting mode of embodiment, an organizational entity ST comprises another organizational entity ST_A called an organizational subentity.

Operational entity EO is understood to refer to an entity representative of a project, request or task carried out by one or more intervening units ITV.

Therefore, in non-limiting modes of embodiment, an operational entity EO may be:
a first-level entity EO_P;
a second-level entity EO_D;
a third-level entity EO_T.

The rest of the description will also name:
the first-level operational entity EO_P a “Project” entity,
the first-level operational entity EO_D a “Request” entity,
the first-level operational entity EO_T a “Task” entity.

A “Project” entity is representative of a project to carry out by one or more intervening units ITV. A “Request” entity is representative of a request issued from one or more intervening units ITV. A “Task” entity is representative of a task to be carried out by one or more intervening units ITV.

In a non-limiting mode of embodiment, the application management system SYS comprises a hierarchy of levels associated with operational entities EO in which:
A first-level operational entity EO_P is suitable for being directly connected to an organizational entity ST regardless of the hierarchical level of the entity ST;
A second-level operational entity EO_D is suitable for being directly connected to a first-level operational entity or to an organizational entity ST; and
A third-level operational entity EO_T is suitable for being directly connected to a second-level operational entity EO_D and/or organizational entity ST, each level of a space D may be connected to each level of another space D, i.e., an operational entity of a level of a space D may be connected to an operational entity of another level of another space D.

In a non-limiting mode of embodiment, the connection between an operational entity EO and an organizational entity ST is carried out via physical pointers between the entity EO and the entity ST, at the user interface level via suitable interface elements UIe.

It will be noted that it is possible to associate a list of entities ST with an entity EO regardless of the level of the EO. Conversely, several entities EO may be connected regardless of their level to several entities ST, also regardless of their level.

That the third level is lower than the second level, which is lower than the first level is determined by agreement.

Therefore, a “Project” entity may group together a set of “Request” entities and “Task” entities and a “Request” entity may group together a set of “Task” entities.

In a non-limiting mode of embodiment, the connection between an operational entity EO and another operational entity EO is carried out via physical pointers between the two entities EO, at the user interface level via suitable interface elements UIe.

In a non-limiting mode of embodiment, an operational entity EO of a level lower than the first level EO_P is also suitable for being directly connected to another operational entity EO of the same level. Therefore, a “Request” entity may be directly connected to another “Request” entity, and a “Task” entity may be directly connected to another “Task” entity. The entities thus connected will respectively be called subrequests and subtasks.

In a non-limiting example, a “ParentTask” field is used in the physical table associated with an EO_T entity.

In a non-limiting example, a “ParentRequest” field is used in the physical table associated with an EO_D entity.

In a non-limiting mode of embodiment, the application management system SYS comprises a common data space Dc, and a data space D is suitable for inheriting components of organizational and operational entities ST, EO of said common data space Dc. In the same manner, a data space D is suitable for inheriting components of data analysis tools OA and of screens and kinematics SCR of said common data space Dc.

In addition, the common data space Dc itself inherits an initial instance created by default when the connector object ML is launched. This initial instance enables the components to be defined by default.

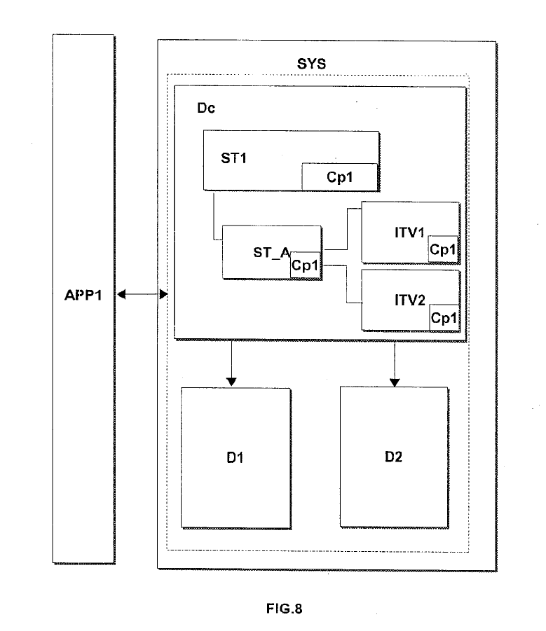

In the rest of the description, the non-limiting example of an application APP1 illustrated in FIGS. 8 to 11 is taken.

In FIG. 8, application APP1 is represented, to which the following are associated:
a common data space Dc;
a first data space D1; and
a second data space D2,

The first space D1 and the second space D2 inheriting from the common data space Dc, the latter comprising the organizational entity ST1 (inheritance illustrated by dotted frames in FIGS. 4 and 5).

Organizational entity ST1 comprises an organizational subentity ST_A to which are connected two intervening units ITV1 and ITV2.

It will be noted that in the example taken, the application APP1 uses several data spaces D. However, conversely, a data space D may contain several applications APP.

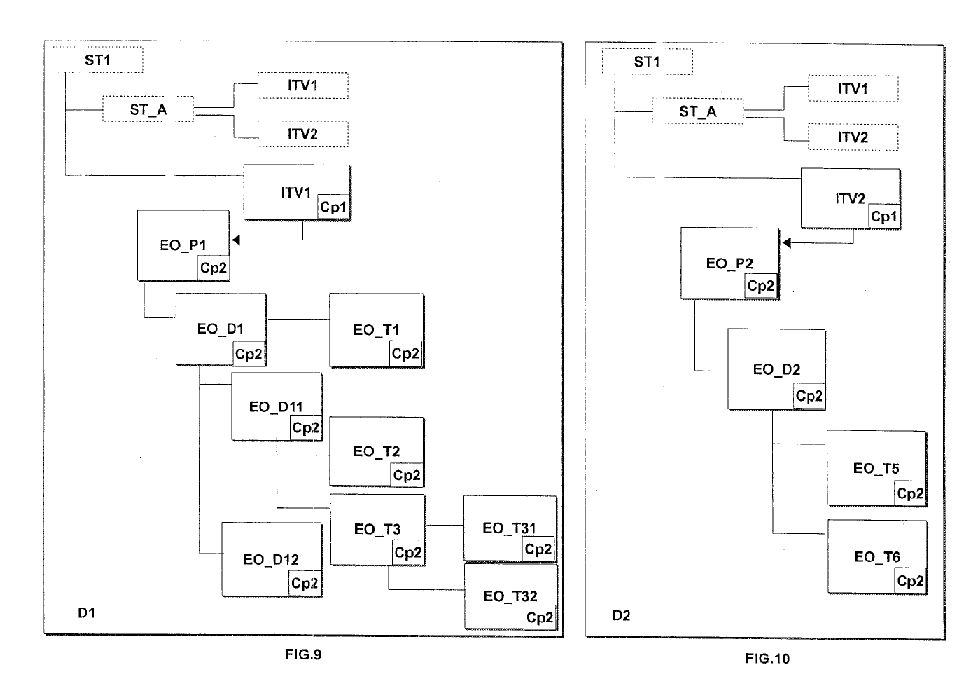

In addition, as illustrated in FIG. 9, data space D1 comprises:
an intervening unit ITV1;
a “Project” entity EO_P1 to which is connected
   a “Request” entity EO_D1 to which are connected
      two “Request” entities EO_D11, EO_D12 that are subrequests;
   a “Task” entity EO_T1;
two “Task” entities EO_T2, EO_T3 connected to the “SubRequest” entity EO_D12 and
two “Task” entities EO_T31 and EO_T32 connected to the “Task” entity EO_T3, that are subtasks.

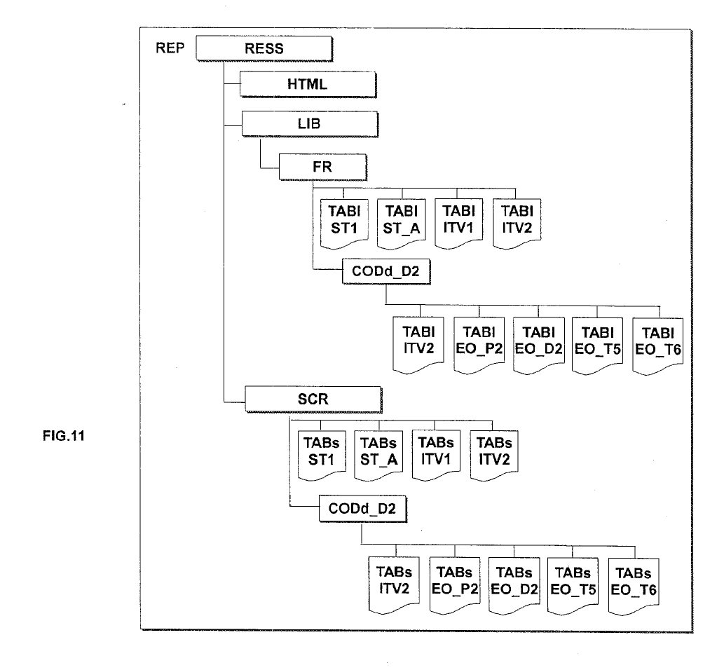

Data space D2 comprises, as illustrated in FIG. 10:
an intervening unit ITV2;
a “Project” entity EO_P2 to which is connected
a “Request” entity EO_D2 to which are connected
two “Task” entities EO_T5 and EO_T6.

In non-limiting modes of embodiment, the organizational entities, “Project,” “Request,” “Task” intervening units comprise the following components Cp1, Cp2 with associated texts.
Organizational entity:
1) Title entity: field
2) Manager: button enabling a screen to be accessed
3) Address and legal data (CTR, Siret, APE, etc.): fields
4) Department: tab enabling a screen to be accessed (enables defining that the organizational entity is a department and that it may be connected to another organizational entity, therefore becoming a lower-level department of the connection organizational entity)
5) Client: tab enabling a screen to be accessed (enables defining that the organizational entity is a client)
6) Supplier: tab enabling a screen to be accessed (enables defining that the organizational entity is a supplier)
7) Workloads: Tab enabling a screen to be accessed (enables access to the workload of the organizational entity to display the operational entities on which the organizational entity is allocated).
   In a non-limiting mode of embodiment, the allocation is carried out by physical pointers between the entities EO and the entities ST, at the user interface level, by suitable fields, tabs, etc.
8) Free zones: tab enabling access to a screen—enables free data to be managed
   Intervening unit:
1) Title: field
2) Name, first name: fields
3) Start date, end date: fields
4) Reference number, badge
5) Address, tel., fax, e-mail: fields
6) Login/password: fields
7) Qualification: list
8) Originating department: list
9) Competency: Tab enabling access to a screen (enables access to the list of competencies of an intervening unit).
10) Workload: Tab enabling access to a screen (enables access to the workload of the intervening unit to display the operational entities on which it is allocated).
   In a non-limiting mode of embodiment, the allocation is carried out by physical pointers between the entities EO and the entities ST, at the user interface level, by suitable fields, tabs, etc.
   In a non-limiting example, an allocation tab such as described below (with dates and loads of the intervening unit on the entity EO) is utilized.
11) Free zones—tab enabling access to a screen—enables free data to be managed
   “Project” entity:
1) Project title—field
2) Code—field
3) Project type—list
4) Open/Closed state—fields
5) Start date—field
6) End date—field
7) Status—list
8) Planning—tab
9) Criticality—list
10) Technical field—list
11) Period—field
12) Department—list
13) Client—list
14) Manager—list
15) Intervening unit allocation—tab enabling access to a screen (enables the intervening units assigned to the “Project” entity to be managed and a load to be assigned to them over a period).
16) Organizational entity allocation—tab enabling access to a screen (enables the organizational entities assigned to the “Project” entity to be managed and a load to be assigned to them over a period).
17) Workload—tab enabling access to a screen (enables the intervening units allocated to the “Project” entity to be managed and a load to be assigned to them over a period).
18) Planning—tab enabling access to a screen (enables the display of the planning of the “Project” entity and the associated intervening units and/or organizational entities).
19) Free zones—tab enabling access to a screen—enables free data to be managed
   “Request” entity
1) Status—list
2) Recipient—list
3) Budget—field
4) Project—list of available “Project” entities
5) Opening date—field
6) Closing date—field
7) Recipient department—list
8) Client—list
9) Issuer—list
10) Original department—list
11) Organizational entity allocation—tab enabling access to a screen (enables the organizational entities assigned to the “Request” entity to be managed and a load to be assigned to them over a period).
12) Intervening unit allocation—tab enabling access to a screen (enables the intervening units allocated to the “Request” entity to be managed and to assign a load over a period to them)
13) Planning—tab enabling access to a screen (enables the planning of a “Request” entity and the associated intervening units and/or organizational entities to be displayed)
14) Solution—tab enabling access to a screen (enables the proposed and retained solutions, associated with the “Request” entity to be managed).
15) Monitoring of costs—tab enabling access to a screen (enables the costs associated with a “Request” entity to be managed
16) Free zones—tab enabling access to a screen—enables free data to be managed
17) Computer stock—list (corresponds to a hierarchical grouping of “Request” entities, work party side). For example, one may have a grouping according to a first hierarchical level per intervening unit ITV and according to a second hierarchical level (dependent on the first level) per version of “Request” entities.
18) User stock—list (corresponds to a hierarchical grouping of “Request” entities, employing party side).
19) ParentRequest—list
20) Type—list
   “Task” entity
1) Task type—list
2) Task code—field
3) Start date—field
4) End date—field
5) Open—field
6) Closed—field
7) Budget—field
8) Project—field
9) Request—field
10) Organizational entity allocation—tab enabling access to a screen (enables the organizational entities allocated to the “Task” entity to be managed and a load to be assigned to them over a period).
11) Intervening unit allocation—tab enabling access to a screen (enables the intervening units allocated to the “Task” entity to be managed and a load to be assigned to them over a period).
12) Loads—tab enabling access to a screen (enables the temporal elements of periods and loads associated with the “Task” entity to be Managed)
13) Free zones—tab enabling access to a screen—enables free data to be managed
14) ParentTask—list

Creation, utilization and administration actions that may be carried out by a user are described below.
Creation and administration of an application APP

When a first-level user U1 wants to create the application APP1, from the user interface UI, he will associate the following with the application APP1 that he wants to create:
The common data space Dc comprising, as illustrated in FIG. 8:
The organizational entity ST1 comprising:
a plurality of first components Cp1; and
an administrative structure ST_A to which are connected two intervening units ITV1, ITV2, also comprising a plurality of components Cp1.
The first data space D1, as illustrated in FIG. 9:
That inherits from the organizational entity ST1 of the common space Dc;

And that comprises:
a first redefined intervening unit ITV1 also comprising Cp1 components;

Nine operational entities EO_P1, EO_T1, EO_D1, EO_D11, EO_D12, EO_T2, EO_T3, EO_D12, EO_T31, EO_T32, EO_T3, each comprising a plurality of second components Cp2;

the first and second components Cp1, Cp2 being activated/deactivated by parameterization within said first data space D1 according to the created application APP1.

It will be noted that the organizational entities ST represent logical groupings of private individuals (that are the intervening units). A logical grouping may be in non-limiting examples a company, a management, a project group, a BIM, an association, a steering committee, a quality group, etc.

Therefore, a space D comprises one or more organizational entities ST as well as one or more intervening units, the latter be connected or not to one or more organizational entities ST.
The second data space D2, as illustrated in FIG. 10:
That inherits from the organizational entity ST1 of the common space Dc;

And that comprises:
a second redefined intervening unit ITV2 also comprising Cp1 components;
Four operational entities EO_P2, EO_D2, EO_T5, EO_T6 each comprising a plurality of second components Cp2;
   the first and second components Cp1, Cp2 being activated/deactivated by parameterization within said second data space D2 according to the created application APP1.

In non-limiting modes of embodiment, the first and second components Cp1 and Cp2 enable the following to be defined:
Fields,
Texts, part of which may be associated with the fields,
Buttons,
Dropdown lists,
Menus,
Tabs, etc.

That compose the screens SCR of the application representative of entities ST, EO.

It will be noted that controls, management rules, procedure processing elements (workflow), hidden management elements linked to the activation and especially the deactivation applied to components Cp1, Cp2, etc., are associated with these components Cp1, Cp2.

Thus, in a non-limiting example, when an application APP only manages intervening units without connection to an organizational entity ST, a hidden management element enables these intervening units to be connected to an inactivated organizational entity ST in order to maintain data consistency.

It will be noted that the application management system SYS also comprises interface elements UIe enabling the creation of:
A data space D;
An organizational entity ST; and

An operational entity EO.

Therefore, when application APP1 is created and administered, a first-level user U1 will be able to perform, in the non-limiting modes of embodiment, the following operations.
Define a common data space Dc;
Define a data space D (that inherits from the common data space Dc);
Define organizational and operational entities;
Reference an organizational entity ST in a data space D;
Reference an operational entity EO in a data space;
Redefine the components of a data space D with relation to the components inherited from the common data space Dc;
Activate/deactivate the components Cp1, Cp2 within a same data space D;
Freely parameterize the new components Cp1, Cp2;
Define a definition base of rules associated with components Cp1, Cp2;
Attribute first accreditation levels to an intervening unit ITV of an organizational entity ST;
Attribute a plurality of rights R attributable to actions A suitable for being performed by an intervening unit ITV;
Attribute second accreditation levels Accr2 attributable to at least one user profile with which the intervening units ITV are associated;
Define rights of accessibility to components of a “Request” entity according to a state of progress and an intervening unit role;
Automatically propagate the definition of a component from one entity in another;
Activate a parameterizable processing procedure according to a type of operational entity; and
Define the data analysis tools OA

The operations are described below.

### Definition of a Common Data Space Dc

It will be noted that the objects (and their components) contained in the common data space Dc are visible by all other data spaces D. Therefore, transverse objects will be found in the common space Dc.

In a non-limiting mode of embodiment, to define a common data space Dc, the administrator user U1 will define, as illustrated in FIG. 11:
texts from the common space Dc in associated tables TABI that will directly be in the directory LIB-FR of the file system REP described previously (in the case of texts in French);
fields, buttons, lists, menus, tabs, etc. of screens SCR relative to this common space Dc in associated tables TABs that will directly be in the directory SCR of the file system REP described previously.

Therefore, in the example of application APP1, there will be:
four tables TABI for the texts of organizational entities ST1, ST_A and intervening units ITV1, ITV2;
four tables TABs for the fields of organizational entities ST1, ST_A and intervening units ITV1, ITV2.
   Definition of a Data Space D (that Inherits from the Common Data Space Dc)

In a non-limiting mode of embodiment, to define a data space D, the administrator user U1 performs the following operations. At the user interface U1 level, he uses, in a non-limiting example, the following interface elements UIe:
a “Space” menu that will make a corresponding screen SCR appear displaying all of the existing spaces D (including the common space Dc);
a “select” button or “new” button to respectively select an existing space or create a space D.
a following screen SCR (following activation of the “new” button) comprising:
   a “code” field to enter a codification CODd of the space D created;
   a “text” field to enter the text LIBd of the created space D.

In this action, in a non-limiting mode of embodiment, a space table Tink is created with:
the codification CODd of the space D created;
the text LIBd of the space D created.

It will be noted that the same is true for the common space Dc.

In the example of application APP1, we will therefore have as a logical representation of the space table Tink:

| Codification | |
|---|---|
| space | Text space |
| CODd Dc | LIBd Dc |
| CODd D1 | LIBd D1 |
| CODd D2 | LIBd D2 |

At the file system REP level, the administrator user will create:
a first subdirectory under directory LIB, having as its name the codification name CODd of the new space created D;
a second subdirectory under directory SCR, having as its name the codification name CODd of the new space created D.

Therefore, concerning application APP1, to create space D2, at the file system REP level, the administrator user U1 will create, as illustrated in FIG. 11:
a first subdirectory under directory LIB, having as its name the codification name CODd of the new space created D2;
a second subdirectory under directory SCR, having as its name the codification name CODd_D2 of the new space created D.

It will be noted that a space D is suitable for automatically inheriting components of organizational and operational entities of said common data space Dc.

Therefore, in a non-limiting mode of embodiment, the application management system SYS comprises a device (not illustrated in the Figs.) for searching Components of a data space D in the associated directories (created above) (during utilization of application APP) and if no component (i.e., associated tables TABs, TABI) is found, the search device searches for said components at the level of the common space. In a non-limiting example, the search device Treq is a request REQ for example in SQL™ format.

Therefore, the management tools MG_T enabling the building of logic networks comprising data spaces particularly comprise the elements seen above:
The user interface suitable for creating a space (Space menu, buttons, screen seen above):
The space table Tlnk;
The LIB, LIB-FR, SCR subdirectories;
The search device cited above; and
The TABI, TABs tables.

It will be noted that links are activated by using a screen entity (user interface) that enables the starting level in the first space and the final level in the second space to be indicated.

It will be noted that a processing is characterized by the indication in a table (Yes/No) of the activation of a processing described in a file. A stream is characterized by a list of steps with sequence logic in one or more spaces.

Processes and streams may be associated in the same way by the indication in a table of the activation of a process that determines the stream at the level of a step or a sequence of steps.

### Definition of Organizational and Operational Entities

In non-limiting examples, the user utilizes the following interface elements UIe:
to define an organizational entity ST, a “definition of an organizational entity” menu in the SCR screen corresponding to the created space D for which it will define the values of the components Cp1 that are active;
to define an operational entity EO, a “definition of an operational entity” menu in the SCR screen corresponding to the created space D for which it will define the values of the components Cp2 that are active.

The administrator user U1 may therefore use these interface elements UIe to create entities relative to the application APP1 and corresponding screens SCR to said created entities for which it will define the values of components Cp1, Cp2 that are active. For this purpose, at the physical level, the text tables TABI and the screen tables TABs associated with each organizational entity ST and operational entity EO will be created.

The meaning of an active component is described below in the description.

In the non-limiting modes of embodiment, the user interface UI comprises an interface element UIe for each type of operational entity, for a “Project” entity, a “Request” entity and a “Task” entity.

### Referencing an Organizational Entity ST in a Data Space D

To establish a referencing of an organizational entity ST in a data space D, in a non-limiting mode of embodiment, the application management system SYS comprises a referencing device Tlnk of an entity ST, EO in a data space D, said device Tlnk comprising at least one first reference to said entity and a second reference to said associated data space.

In a non-limiting mode of embodiment, the referencing device Tlnk is the space table described previously comprising a first reference to said entity associated with a second reference to said data space, and this second reference is the codification CODd of the created space D seen previously.

In the example of the application APP1 taken previously, for the common space Dc, one will have, therefore, in the space table Tlnk:
a line comprising the reference ST1 and the associated codification line CODd_Dc;
a line comprising the reference ST_A and the associated codification line CODd_Dc; and
a line comprising the reference ITV1 and the associated codification line CODd_Dc.

In the same manner, for the space D1, one will thus have in the space table Tlnk, a line comprising a reference to the organizational entity ITV1 of space D1, associated with the codification line of the space field D1.

In the same manner, for the space D2, one will thus have in the space table Tlnk, a line comprising a reference to the organizational entity ITV2 of space D2, associated with the codification line of the space field D2.

One thus obtains the logical representation of the following referencing device Tlnk.

| Codification | | Referenced |
|---|---|---|
| space | Text space | entities |
| CODd Dc | LIB Dc | ST1 |
| CODd Dc | LIB Dc | ST A |
| CODd Dc | LIB Dc | ITV1 |
| CODd D1 | LIB D1 | ST D1 |
| CODd D1 | LIB D1 | ITV1 |
| CODd D2 | LIB D2 | ST D2 |
| CODd D2 | LIB D2 | ITV2 |

Therefore, when the user will create an organizational or operational entity via the suitable interface elements UIe, the space table will be automatically filled in.

### Referencing of an Operational Entity EO in a Data Space

The same principle as that described above for an organizational entity ST applies in the case of an operational entity EO.

Therefore, the logical representation of the following referencing device Tlnk is obtained for the application APP1 taken as a non-limiting example.

| Codification | | Referenced |
|---|---|---|
| space | Text space | entities |
| CODd_Dc | LIB_Dc | ST1 |
| CODd_Dc | LIB_Dc | ST_A |
| CODd_Dc | LIB_Dc | ITV1 |
| COD_D1 | LIB_D1 | ITV1 |
| COD_D1 | LIB_D1 | EO_P1 |
| COD_D1 | LIB_D1 | EO_D1 |
| COD_D1 | LIB_D1 | EO_D11 |
| COD_D1 | LIB_D1 | EO_D12 |
| COD_D1 | LIB_D1 | EO_T1 |
| COD_D1 | LIB_D1 | EO_T2 |
| COD_D1 | LIB_D1 | EO_T3 |
| COD_D1 | LIB_D1 | EO_T31 |
| COD_D1 | LIB_D1 | EO_T32 |
| COD_D2 | LIB_D2 | ITV2 |
| COD_D2 | LIB_D2 | EO_P2 |
| COD_D2 | LIB_D2 | EO_D2 |
| COD_D2 | LIB_D2 | EO_T5 |
| COD_D2 | LIE_D2 | EO_T6 |

Redefinition of Components of a Data Space D with Relation to Components Inherited from the Common Data Space Dc

In a non-limiting mode of embodiment, the application management system SYS comprises a device to redefine Tdef components Cp1, Cp2 of organizational entities ST and operational entities EO of a data space D with relation to the components inherited from a common data space Dc.

In a non-limiting example, the redefinition device Tdef is a set of tables TABI, TABs associated with said space D.

At the file system REP level, the administrator user U1 will create:
Tables TABI relative to the texts (to be defined/redefined) of screens of the created space D in the first subdirectory under the directory LIB, having as its name the codification name CODd of the created space D;
all the tables TABs relative to the fields, buttons, lists, menus, tabs, etc. (to be defined/redefined) of screens SCR of the created space D in the second subdirectory under the directory SCR, having as its name the codification name CODd of the created space D.

Therefore, concerning the application APP1 created, we will have the file system REP illustrated in FIG. 11 for space D2:
Five text tables TABI to respectively define the texts of entities ITV2, EO_P2, EO_D2, EO_T5 and EO_T6
Five screen tables TABs to respectively define the screens SCR of entities ITV2, EO_P2, EO_D2, EO_T5 and EO_T6

In the example taken, all the components of space D2 are defined and the intervening unit ITV2 has been redefined with relation to that defined in common space Dc.

The same principle applies for space D1.

It will be noted that in the case where a component Cp1, Cp2 of an organizational, operational entity enables access to another component (example, the case of a tab, button, etc.), this other component is also defined in the file system REP.

Therefore, for example, in the case of a “Project” entity, components 15), 16), 17) and 18) enable access to other components, in the example taken of components representative of other screens, the latter also being defined by means of tables TABI and TABs in the file system REP.

### Activation/Deactivation of Components of an Entity

After the components of an entity have been defined/redefined, they must be activated in order to choose what components to use for each defined entity.

In order to activate/deactivate by parameterization the first components Cp1 of an organizational entity ST and the second components Cp2 of an operational entity EO within a same data space D, in a non-limiting mode of embodiment, the application management system SYS comprises a first activation device Tact1 of components of an entity ST, EO.

A first activation device Tact1 of components of said entity ST, EO is associated with each entity.

In a non-limiting mode of embodiment, the first activation device Tact1 is also a table in text file form.

Therefore, in a non-limiting example, a table Tact1 will comprise all defined components Cp1, Cp2 of an entity ST, EO with an activation flag to be positioned at 1 or 0 to respectively activate or deactivate the associated component.

It will be noted that a nonparameterized entity in a data space D (that therefore does not have a corresponding table Tact1) is not visible in this space D. Data from this entity will come from other spaces D in which the entity is parameterized.

Therefore, in the example of application APP1 taken previously, there will be:
For the common space Dc, four tables Tact1 respectively associated with four objects ST1, ST_A, ITV1, ITV2;
For the first space D1, ten tables Tact1 respectively associated with ten defined objects (ITV1, EO_P1, EO_D1, EO_D11, EO_D12, EO_T1, EO_T2, EO_T3, EO_T31, EO_T32) in said space D1; and
For the second space D2, five tables Tact1 respectively associated with five defined objects (ITV2, EO_P2, EO_D2, EO_T5, EO_T6) in said space D2.

Therefore, the administrator user U1 very simply fills out these tables Tact1 in order to activate/deactivate the components by parameterization, and positions the associated flag opposite each component.

Therefore, in the user interface UI, screens SCR corresponding to the entities will only display the activated Cp1, Cp2 components. Therefore, when the application is used, the screens will only display the components of tables TABs that have been activated in the tables Tact1.

It will be noted as seen previously (definition/redefinition of components), components Cp1, Cp2 accessible via other components also have associated tables Tact1.

It will be noted that a component is activated/deactivated within a same space D. Therefore, to associate the activation tables Tact1 to a target data space D, a search request REQ is utilized in a non-limiting embodiment. This request REQ, from the reference of an entity (seen previously) in the data space table Tink, enables having direct access to the component activation/deactivation table.

Therefore, in a non-limiting example, if a “Project” entity comprises components Cp2 with associated texts such as described previously, one may for example have in the first space D1, the project EO_P1 with all the active components that will therefore be visible (or active) on the corresponding screen SCR, and in the second space D2, the project EO_P2 with only components 2) to 8) active that will therefore be visible (or active) on the corresponding screen SCR.

One will therefore have a logical representation of a following activation/deactivation table Tact1 for the above “Project” entity example.

For field D1:

| Component | Flag |
|---|---|
| 1) Project title - dynamic | 1 |
| field | |
| 2) Code - dynamic field | 1 |
| 3) Project type - dynamic | 1 |
| list | |
| 4) Open/Closed state - fields | 1 |
| 5) Start date - dynamic field | 1 |
| 6) End date - dynamic field | 1 |
| 7) Status - dynamic list | 1 |
| 8) Planning - tab | 1 |
| 9) Criticality - dynamic list | 1 |
| 10) Technical field - dynamic | 1 |
| list | |
| 11) Period - field | 1 |
| 12) Department - list | 1 |
| 13) Client - list | 1 |
| 14) Manager - list | 1 |
| 15) Intervening unit | 1 |
| assignment | |
| 16) Organizational entity | 1 |
| assignment | |
| 17) Workload | 1 |
| 18) Planning | 1 |

For field D2:

| Component | Flag |
|---|---|
| 1) Project title - dynamic | 0 |
| field | |
| 2) Code - dynamic field | 1 |
| 3) Project type - dynamic | 1 |
| list | |
| 4) Open/Closed state - fields | 1 |
| 5) Start date - dynamic field | 1 |
| 6) End date - dynamic field | 1 |
| 7) Status - dynamic list | 1 |
| 8) Planning - tab | 1 |
| 9) Criticality - dynamic list | 0 |
| 10) Technical field - dynamic | 0 |
| list | |
| 11) Period - field | 0 |
| 12) Department - list | 0 |
| 13) Client - list | 0 |
| 14) Manager - list | 0 |
| 15) Intervening unit | 0 |
| assignment | |
| 16) Organizational entity | 0 |
| assignment | |
| 17) Workload | 0 |
| 18) Planning | 0 |

Therefore, this parameterization by data space D enables having a very flexible application APP1 management.

It will be noted that in a non-limiting mode of embodiment, the application management system SYS also comprises means to verify the consistency in real time between the objects at activation or the deactivation of an object.

The activation of a datum involves the generation of tables or table items necessary for enabling the associated activations: Activation of criteria associated with the datum, integration of the datum in the screen entities or summary tables. When a datum mandatory for system consistency is deactivated, the system takes in charge, in the “back office,” the management of this datum to maintain consistency without impacting the application under consideration.

In addition, it will be noted that in a non-limiting mode of embodiment, the application management system SYS also comprises a qualification device QUAL suitable for defining an organizational entity ST even if it is not utilized (it is therefore deactivated) in the created application APP, in order to maintain data consistency.

The organizational entity thus qualified therefore is not visible to the user, but exists all the same.

Definition is done by means of tables TABI and TABs seen previously but that will not be accessible by the application APP. In these tables TABI, TABs, at least one component (field, tab, menu, list, etc.) Is defined, i.e., comprises a value by default, but is not visible to the application APP, i.e., is not activated. The other undefined components are also not activated.

In order to maintain data consistency, when an application APP uses intervening units but no organizational entity, the qualification device QUAL performs a logical connection of the intervening units with the organizational entity ST defined above by default. At the physical level, a pointer in an intervening unit to the organizational entity ST is used.

In addition, it will be noted that the tools ID_T (cited above) for identifying possible activations of objects linked to an initial activation of an object enable the automatic verification and activation of objects and/or components that are linked to an object and/or component activated by the user, and that the user has forgotten to activate. Therefore, for example, the “start date” component of a Project object has been activated, but not the “end date” component by the user. The identification tools ID_T therefore automatically activate the “end date” component.

### Free Parameterization of New Components Cp1, Cp2

In a non-limiting mode of embodiment, the application management system SYS also comprises a device Tpf to freely parameterize new components Cp1, Cp2 in an entity ST, EO in an analysis tool QA or in a screen SCR.

In a non-limiting variation of embodiment, this parameterization device is a plurality of blank lines in an entity ST, EO activation device Tact1.

This enables an evolution of entities to be obtained.

Therefore in the example of the application APP1 taken and of project EO_P1, one may add a line 19) “intervening party allocation”—tab that enables the intervening parties allocated to said project EO_P1 to be managed, which corresponds to the free zones described previously. A field that is already defined but that has not been activated before and that will be activated at 1 may also exist.

Define a Definition Base of Rules Associated with Components Cp1, Cp2 of an Entity ST, EO

In a non-limiting mode of embodiment, the application management system SYS also comprises a definition base of rules Tbdr associated with components Cp1, Cp2 of an entity ST, EO so as to verify the consistency in real time of a screen. This enables rules relative, for example, to a sequence of steps in a “Project” entity to be defined.

In a non-limiting mode of embodiment, the rule definition base Tbdr is defined in a table in text format. This table Tbdr will be verified every time that a component Cp1, Cp2 is generated by an administrator user U1 or final user U2 via the user interface UI. In a non-limiting mode of embodiment, the language used to define the rules is in text format.

Therefore, for example, in the example taken of the application APP1, in first space D1, one may define a rule on a “Closing Date” component Cp2 of a “Request” entity EO_D11 according to which if the closing date is defined, then one may go to the next “Request” entity EO_D12. This enables consistency in the application APP1 to be maintained. The administrator user U1 will be able to define a rule base by simply filling in the table Tbdr.

### Attribution of Accreditation N and Rights R Levels

In order to carry out the attribution operations of accreditation N and rights R levels, the application management system SYS comprises an accreditation device Ta comprising:
A plurality of first accreditation levels N1 attributable to an intervening unit ITV of an organizational entity ST;
A plurality of rights R attributable to actions A suitable for being performed by an intervening unit ITV;
A plurality of second accreditation levels N2 attributable to at least one user profile PR with which the intervening units ITV are associated;
Said first and second accreditation levels N1, N2 and said plurality of rights R being suitable for being combined with each other.

The levels and rights are defined below.
Definition of first accreditation levels N1

In a non-limiting mode of embodiment, five first accreditation levels N1 are defined.
N1P=Personal
N1S=Department
N1SF=lower-level department
N1G=General
The level N1P represents accreditations relative to an intervening unit connected to an application APP.

It will be noted that a “connected” intervening unit is different from a private individual user. The connected intervening unit is the login/password recognized by the application management system SYS and to which rights R have been allocated.

At the N1P level, a connected intervening unit has accreditations on objects with which it has a direct link. A direct link exists when there is correspondence between the password of the connected intervening unit and the intervening unit that is the “possessor” of the object. For example, the possessor of a “Request” object is the issuer of the “Request” (as defined previously in the “Request” entity as component 9), the possessor of a “Project” object is the manager of the “Project” (as defined previously in the “Project” entity as component 14), etc.
The N1S level represents the accreditations relative to a connected intervening unit that has rights R on the objects managed by the organizational entity and department of the intervening unit. The intervening unit department is for example indicated in a component of the organizational entity department of the intervening unit (component 8 defined previously).
The N1SF level represents the accreditations relative to a connected intervening unit that has rights R on the objects managed by the organizational entity and lower-level department of the intervening unit. A lower-level department organizational entity is for example indicated in a component of the organizational unit entity (component 4 defined previously).

It will be noted that in a non-limiting mode of embodiment, the accreditations allocated at the level of a department are not inherited by default by the lower-level departments. In the same manner, the accreditations allocated at the lower-level department are not given by default to the department.
The level N1G represents accreditations relative to a connected intervening unit that has rights R allocated to all objects managed in the application management system SYS.
   Definition of second accreditation levels N2

In a non-limiting mode of embodiment, at least one user profile PR to which intervening units are associated may be associated with a data space D.

It will be noted that an intervening unit may belong to several user profiles PR.

Therefore, the administrator user U1 may create user profiles PR and then attribute intervening units to them all via the suitable interface elements UIe.

Subsequently, the administrator user U1 may attribute a plurality of second accreditation levels N2 to at least one user profile PR to which intervening units ITV are associated via suitable interface elements UIe.

At the physical level, at this time, the accreditations table Ta corresponding to the second accreditation levels N2 will point to the intervening unit ITV and/or the associated user profile PR.

It will be noted that the second accreditation levels N2 are defined in the same way as the first accreditation levels N1, i.e.:
N2P=Personal
N2S=Department
N2SF=Lower-level department
N2G=General

In non-limiting examples, one may have user profiles PR relative to:
project leaders
department managers
administrators
the work party
the employer
different occupational profiles, etc.
   Definition of rights R

In a non-limiting mode of embodiment, five rights R attributable to actions A (reading, writing, creation, deletion, administration) are defined and are applicable to each accreditation level N1, N2.
RL=Reading: A connected intervening unit/connected user profile has access to objects only in reading.
RE=Writing: A connected intervening unit/connected user profile has access to objects only in writing (modification alone without the ability to create or delete). It will be noted that in a non-limiting mode of embodiment, the right RE involves the right RL.
RC=Creation: A connected intervening unit has access to objects in creation. It will be noted that the right RC does not include the rights RE and RL.
RS=Deletion: A connected intervening unit/connected user profile has access to objects in deletion. It will be noted that the right RS does not include the other rights.
RA=Administration: A connected intervening unit/connected user profile has access to objects in administration. The right RA includes all rights RL, RE, RC and RS.
RP=right of modification of components and steps of a “Request” entity. A connected intervening unit/connected user profile has validator status (as explained below in the description).

The following non-limiting examples illustrate the attribution of rights R for an intervening unit ITV.

### Example 1

An intervening unit having only creation and modification rights at the N1P level for a “Request” object will be able to create a “Request” entity and modify the “Request” entities for which it is the issuer. It will not be able to access the requests for which it is not the issuer. In a non-limiting example, as seen previously, a “Request” entity comprises an Issuer field in which the administrator user U1 may enter the name of the “Request” entity issuer.

### Example 2

An intervening unit having reading rights at the N1S level for a “Project” object will be able to consult all the “Project” entities of the Department to which it belongs.

In a non-limiting example, a “Project” entity comprises a department field in which the administrator user U1 may enter the name of a Department that is responsible for the “Project” entity.

In a non-limiting example, an intervening unit is allocated to a department over a period via an intervening unit corresponding component (with management of validity dates of the intervening unit entities).

### Example 3

An intervening unit having reading rights only at the N1SF level for a “Task” object will be able to consult the tasks of requests connected to one of the subdepartments dependent on its department. In a non-limiting example, an intervening unit is allocated to a department over a period via an intervening unit corresponding component (with management of validity dates of the intervening unit entities). It will be automatically propagated to the subdepartments of this department. The same examples may be taken for a user profile PR.

Therefore, for the definition of first N1 and second N2 accreditation levels, in a non-limiting mode of embodiment, the administrator user U1 may utilize suitable interface elements UIe to:
choose the data space D or Dc in which it wants to define the accreditation levels.
Then, choose the user profile PR or an intervening unit according to which it wants to define the accreditations for a user profile or an intervening unit.
Choose the accreditations N1, N2 to give and the associated rights R.

In a non-limiting mode of embodiment, the accreditation device Ta is suitable for attributing a right R on actions A associated with a data space D, entity ST, EO, component Cp1, Cp2.

In a non-limiting mode of embodiment, the accreditation device Ta comprises a table associated with the chosen space D or Dc, and with the intervening unit or chosen user profile PR, in which:

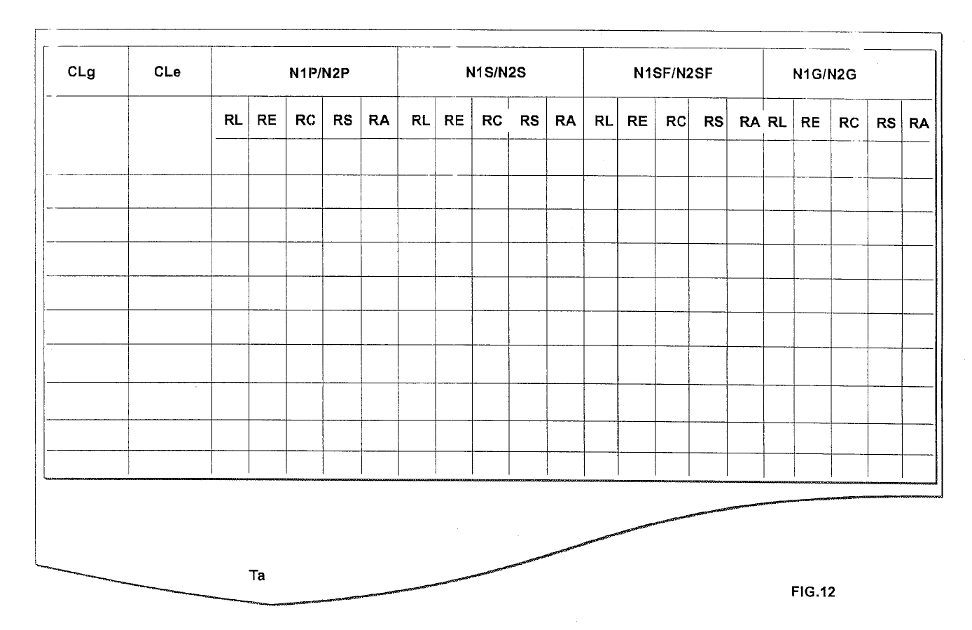

For each first accreditation level N1, there are the associated rights RL, RE, RC, RS, RA, each accreditation level N1 being associated with a class CLg, a class CLg defining an entity or component on which one wants to attribute a level and a right, such as illustrated in FIG. 12, in a logical representation.

In a non-limiting mode of embodiment, the accreditation device Ta is a table. Therefore, thanks to this multi-dimension accreditation table Ta, the first and second accreditation levels N1, N2 and the plurality of rights R may be combined with each other.

In addition, it will be noted that the accreditation table Ta comprises an additional column Cle comprising the specific denomination of each entity or component of a data space D, while column CLg comprises the generic denomination for each entity or component for an application APP.

It will be noted that accreditations N1, N2 described above are defined by data space D. In this case, the accreditations N1, N2 are only valid in the space where they are defined.

In a non-limiting mode of embodiment, it will be noted that accreditations N1, N2 defined for the common data space Dc are applicable for all spaces D. Therefore, a space D inherits the accreditations given to an intervening unit/user profile in the common space Dc. This avoids having to give identical rights again in all data spaces D. Therefore, a factoring of rights is performed.

Therefore, accreditations N1, N2 both managed in the common space Dc and a space D for an intervening unit/user profile lead to cumulative rights R attributable to actions (the maximum right defined is that retained).

### Define Rights of Accessibility Attributed to Components of a “Request” Entity According to a State of Progress Step and an Intervening Unit Role Ro

The application management system SYS comprises an accessibility device Tacc for components Cp1, Cp2 of an operational entity EO according to a state of progress Step of the operational entity EO and a role Ro attributed to an intervening unit ITV of an organizational entity ST, the state of progress Step being suitable for being applied to several spaces D by respecting the different instances (i.e., by respecting the different activation and personalization sets). It will be noted that a state of progress is situated in a “workflow” cited above.

The connected intervening unit has roles Ro according to information entered in the application management system SYS, either with relation to the organization of the intervening units, or with relation to a “Request” entity. It will be noted that a same intervening unit may have several roles simultaneously. It will be noted that the role Ro of an intervening unit is automatically known from the application management system SYS according to the information inputted by it (name, first name, login, password).

In non-limiting modes of embodiment, the roles Ro attributable to an intervening unit are:
No role: a “Request” entity is not visible by the intervening unit
RoEM=Issuer Role: the issuer of a “Request” entity is the connected intervening unit
RoRU=user manager role=
   If the connected intervening unit is a validator; or
   If the connected intervening unit is the computer manager, more precisely, the manager of the recipient department organizational entity, in charge of producing the “Request” entity; or
   If the connected intervening unit is the manager of the issuer department of the “Request” entity; or
   If the connected intervening unit department is the issuer department of the “Request” entity.

It will be noted that a validator is an intervening unit that may modify the components and steps in a “Request” entity and that belongs to the department that is at the origin of this “Request.”
Rol=Computer manager role:
   If the connected intervening unit is a validator; or
   if the connected intervening unit has the administrator role; or
   if the connected intervening unit has the project leader role; or
   if the connected intervening unit is the manager of the recipient department (department that carries out the Request) of the “Request” entity;
or
   the department of the connected intervening unit is the recipient department (department that carries out the Request) of the “Request” entity.
RoCU=Corresponding User Role: If the connected intervening unit is the manager of a “user stock” component of the “Request” entity. In practice, this corresponds to the managers of the stock of the “Request” entities, employing party side, i.e., order giver side.
RoCI=Corresponding Compute Role: If the connected intervening unit is the manager of a “computer stock” component of the “Request” entity. In practice, this corresponds to managers of the stock of the “Request” entities, work party side, i.e., producer side.
RoCp=Project Leader Role: If the connected intervening unit is the manager of the “Project” entity to which the “Request” entity is connected.
RoRT=Administrator Role: if the login of the connected intervening unit is an administrator login.

In non-limiting modes of embodiment, the states of progress Step of a “Request” entity are:

| States of the | | |
|---|---|---|
| Request | Type | Meaning |
| Deleted State | SteO | Deleted Request |
| Initial State | Ste1 | Request in draft mode |
| Requester | Ste2 | Request being |
| State | | processed on the |
| | | Requester side |
| Personalized | Ste4 | State that may be |
| State | | personalized |
| Producer State | Ste5 | Request being |
| | | processed on the |
| | | producer side |
| Terminated | Ste8 | Request processing |
| State | | terminated |
| Rejected State | Ste9 | Request processing |
| | | rejected |

In a non-limiting mode of embodiment, the accessibility device Tacc (that confers the possibility of modifying a component) on components of a “Request” entity according to a role Ro of an intervening unit and a state of progress Step comprises:
1) A table Tcp of components Cp1, Cp2 of screens corresponding to a “Request” entity that comprises:
The texts LIB of components; and
An associated code component VAL;

Therefore, in a non-limiting example, one will have a following table Tcp associated with a “Request” entity:

| Text LIB of screen components | |
|---|---|
| Cp1, Cp2 | Code VAL |
| Status | 1 |
| Recipient | 2 |
| Budget | 3 |
| Project | 4 |
| Opening date | 5 |
| Closing date | 6 |
| Recipient department | 7 |
| Client | 8 |
| Issuer | 9 |
| Original department | A |
| Components for the | B, . . . |
| Organizational entity | |
| allocation tab | |
| Components for the Intervening | C, . . . |
| unit allocation tab | |
| Components for the Planning | D, . . . |
| tab | |
| Components for the Solution | E, . . . |
| tab | |
| Components for the Cost | F, . . . |
| monitoring tab | |
| Components for the Free zones | G, . . . |
| tab | |

2) A parameterization table Tprm enabling the components Cp1, Cp2 of a “Request” entity that are accessible according to the role Ro of a user to be defined.

Therefore, in a non-limiting example, one will have a following table Tprm associated with a “Request” entity:

| Request states | Type | Modifiable zone |
|---|---|---|
| Deleted state | SteO | |
| Initial state | Ste1 | RoEM[147]; etc. |
| Requester | Ste2 | |
| state | | |
| Personalized | Ste4 | |
| state | | |
| Producer state | Ste5 | |
| Terminated | Ste8 | |
| state | | |
| Rejected state | Ste9 | |

The syntax of the modifiable zone is as follows: Role 1[List of components Cp1, Cp2 accessible for this role]; Role 2[List of components Cp1, Cp2 accessible for this role]; . . . Rolen[List of components Cp1, Cp2 accessible for this role]. Therefore, in the explanatory example for the step Stet, the user who has an Issuer role has the right to modify the Status, Recipient department and Project components.

We therefore have a parameterization table Tprm by “Request” entity.

Therefore, the administrator user will only have to complete these tables Tcp, Tprm (or any other equivalent logic table) to determine the rights of accessibility on the components of an operational entity EO, here the “Request” entity according to a role Ro of a user. Therefore, for example, when a user will be positioned on the “Issuer” field of the corresponding “Request” entity, via the suitable interface element UIe, the application management system SYS will verify the parameterization table Tprm associated with the role of the connected intervening unit via a request REQ, for example.

Therefore, thanks to the combination of accreditations, rights R and accessibility rights seen above, one may expertly manage access to entities and components of an application APP.

Device DICO for Automatically Propagating a Definition of a Component from One Entity into Another

In a non-limiting mode of embodiment, the application management system SYS also comprises a device DICO for automatically propagating a definition of a component Cp1, Cp2 from one entity ST, EO, called the original entity, into another entity, called the target entity ST, EO in which it is often found.

In a non-limiting example, the automatic propagation device DICO comprises pointers to components Cp, Cp2 that one wishes to use in another entity. Therefore, a target entity ST, EO comprises at the location where components Cp1, Cp2 must be found, pointers to an original entity ST, EO, this latter comprising a definition of components Cp1, Cp2.

This propagation device may be applied to an entity ST, EO in its entirety.

Therefore, an inter-space link is performed between components Cp1, Cp2 and/or other entities ST, EO.

### Activate a Parameterizable Processing Procedure According to a Type of Operational Entity

In a non-limiting mode of embodiment, the application management system SYS also comprises a second device Tact2 for activating a parameterizable processing procedure WF according to an operational entity EO type TY. Therefore, in a non-limiting example, a type TY is associated with a “Request” entity. Depending on this type TY, access is given to functions peculiar to this “Request” entity. For example, for a given type, the accessible functions are the “Intervening unit allocation” and “Planning tab” tabs such as seen previously; Other “Solution,” “Cost monitoring” and “free zones” function tabs are not accessible.

In one non-limiting example, the second activation device Tact2 is an XML file in which the type TY of operational entity EO is observed and, depending on this type, the target functions are associated. Subsequently, as seen previously, depending on the steps of a “Request” and the role Ro of the user, there is access or no access to certain fields, lists, menus, tabs, etc.

### Definition of the Data Analysis Tools OA

Thanks to a set of indicators, the data analysis tools OA enable the actions in progress or performed of an operational entity, for example, to be monitored.

Therefore, these tools are non-limiting examples:
Summary tables;
Search criteria;
Dynamic trees of data that are displayed on a screen;
Indicators;
Statistics, etc.

An administrator user will define these tools in the following manner:

The tools are activated either at the initiative of the administrator user by the combined indication in a table and one or more activation files or automatically by the system. Following activation of the tool, other activations may be requested. Once all the activations have been carried out, personalization is possible depending on the associated and activated entities and data. For example, activation of an entity status enables displays in the tree or modes of operation of the user interface, or access to screen entities to be activated.
Utilization of an application APP

Therefore, during utilization of an application APP, a second-level user U2 will be able to carry out, in a non-limiting mode of embodiment, the following operations.
Duplicate an operational entity EO.
Transmit components defined by filtering to external management systems.

The operations are described in detail below.

### Duplicate an Operational Entity EO

In a non-limiting mode of embodiment, the application APP1 management system comprises a device Rdp for duplicating an operational entity of Eos origin suitable for utilizing a unit Form for redefining components Cp1, Cp1 of the duplicated operational entity EOd with relation to the operational entity of origin Eos.

In a non-limiting example, an application user may therefore, via the suitable interface elements UIe:
choose a duplication of an operational entity of origin Eos;
choose via the redefinition unit Form the components Cp1, Cp2 of the operational entity of origin Eos, the contents of which it wants to recopy;
choose via the redefinition unit Form the components Cp1, Cp2 of the operational entity of origin Eos, the contents of which it wants to modify;
input the contents of components Cp1, Cp2 that it wants to modify.

The duplicated entity EOd therefore comprises the structure of data from the entity of origin Eos with:
original components Cp1, Cp2 recopied with their original Content;
original components Cp1, Cp2 recopied with a different content inputted by the user during duplication.

At the physical level, in a non-limiting mode of embodiment, the tables TABs and TABI of the entity of origin Eos that have been duplicated will be updated with additional lines corresponding to a duplicated component Cp1 Cp2, the content of which has been modified. A line therefore comprises a code COD_EOd corresponding to the duplicated entity EOd and the inputted content of the modified component Cp1, Cp2. The duplicated entity EOd therefore comprises a pointer to the tables TABs and TABI of the entity of origin Eos. Therefore, this enables the number of tables utilized to be reduced.

### Transmit/Receive Components Defined by Filtering to External Management Systems

When it uses an application APP, a final user U2 may display (via the user interface UI) components of entities ST, EO by using the system for managing data external to the application.

For this purpose, the application management system SYS comprises a generic device Rt for importing/exporting components of said entities ST, EO and/or of said tools OA defined by filtering to data management systems ED suitable for cooperating with application management systems SYS so as to generate a generic stream that is created with activation and personalization sets.

Therefore, according to a chosen application, the import/export device Rt generates a stream dedicated to said application, said stream may be different with relation to another application.

In a non-limiting mode of embodiment, the filtering is carried out by means of a filtering table Tf in text format, in which the components of the entities that one wants to display are defined. In a non-limiting example, a filtering table Tf is associated by entity.

In a non-limiting mode of embodiment, the import/export device Rt calls the URL with the indication of the name of the filtering table Tf to be displayed.

The systems for managing external data ED are, in non-limiting examples, graphs, dashboards and any other system capable of receiving data via a “.csv” or “XML” file, for example.

This enables data determined by filtering in a particular format from external data management systems.

It will be noted that one may also determine the filtering of data with a status allocated to the organizational entity in the application APP user. Therefore, an organizational entity may have the status of Client, Supplier, Payer or Department (the latter status meaning the Department that is the issuer of a request).

Of course, the invention is not limited to the embodiments described.

Therefore, for operational entities, one may for example add a “Comments” component tab with a suitable associated screen.

Therefore, for a “Request” entity, one may have the following additional components: History, Linked requests, Planned monitoring, Real monitoring, Analysis, Tests, Receipt, Request step, Priority, Description, Estimate, Expected gains; Quantifiable gains, Production date, Mandatory date, Receipt date.

Therefore, the process of defining rights of accessibility on components of a “Request” entity according to a state of progress Step and a role Ro may be applied to a “Project” or “Task” entity.

Therefore, according to the associated texts, a first-level operational entity may be different from a Project, a second-level operational entity may be different from a Request, a third-level operational entity may be different from a Task.
Launching an application.

When an application has been created and parameterized, a user uses it in the following manner.

He is connected to the application management system SYS via an initial connection screen SCR INIT with a password “login.” The password “login” is representative of an intervening unit and its role seen previously.

Depending on the password “login,” a list of data spaces D are proposed to the user. The user chooses the data space D in which he wishes to work. He may define a space by default upon connection. If he cannot choose a space, the common space Dc is chosen by default.

At this time, the connector object (ML) implements the generic models, the database, the set of tables and files, said identification and management tools seen previously. Therefore, the application APP that corresponds to an activation and personalization set corresponding to the password “login” is launched.

In a non-limiting mode of embodiment, the user interface UI displays a logic tree of objects from the application. The logic tree displays the organizational ST and operational EO entities and their connection (such as illustrated in FIG. 9 and FIG. 10), the analysis tools OA etc.

With every prompt by the user via the user interface UI (i.e., every time the user is going to click on an object on the tree), the corresponding screen is generated (there is a search by the connector object ML of tables and files corresponding to the activation and personalization of object components, and data from the object to be displayed in the corresponding screen zones).

It will be noted that accreditations corresponding to the user are verified every time that there is a prompt and the objects, components, etc., to which the user has the right of access are displayed on the screen. Therefore, a screen does not exist before the user calls it up. Therefore, a screen is generated in real time.

Therefore, thanks to the activation and personalization sets, an instance INST of the application management system is defined, such an instance being an application. In addition, from an activation and personalization set, and therefore an instance, one may define an extension, i.e., an additional activation and personalization set. By the set of different extensions, different versions of an application are obtained, thus evolving following the example of a software package by successive versions.

Therefore, thanks to the invention, software packages that are defined by users that are not computer scientists are obtained.

These software packages are generated since they may be used for any type of recipient. Only the different activation and personalization sets will enable a determined destination to be defined.

Thus, the invention also presents the following advantages:
The invention enables any user who is not a computer scientist to manage an application and make changes to it;
The invention enables simple parameterization of an application thanks to the group of tables G_TAB;
The invention enables complex applications to be processed;
The invention enables having a very flexible combination of accreditations and rights;
The invention enables, within a same universal set (table group G_TAB), not only projects, requests and tasks to be managed, but also at the same time resources (organizational entities, intervening units) working for these projects, requests and tasks;
The invention enables, within a same universal set (table group G_TAB), different entities from a same group in different management modes (project mode, factual mode, recurrent mode) to be managed. Therefore, in a non-limiting example, for an application relative to an information systems management group DSI, one may manage entities relative to different occupations such as:
studies in which intervening units work in project mode, for example when there is a development of computer tools to be carried out;
production in which intervening units work in factual mode, for example when there is a data stream problem to be sorted out in a computer network;
maintenance in which intervening units work in recurrent mode, for example when computer servers must be maintained in a state of good operation or else dealing with the safety of the computer network.
The invention enables having a logic design for an application thanks to the slicing of logical data in space;
The invention enables having a single non-semantic data base whose data will be characterized thanks to the different activation and personalization sets seen previously;
The invention enables a screen to be displayed in real time according to a contextual analysis (activation and personalization set);
The invention enables having a single data base that manages different spaces and thus different applications, the data base being modified by the values put in the tables and files; and
The invention enables having a data base that comprises different semantics thanks to the different activation and personalization sets associated with a data space or with a set of data spaces.

1. An application management system, the system comprising:
objects comprising one or more predefined and preassembled components, said objects forming:
a generic organization model composed of logic organizational entities suitable for being linked to one another;
a generic management model composed of logic operational entities suitable for being linked to one another;
a generic control model composed of data analysis tools;
a generic model of screens and kinematics for a user interface;
a single predefined physical database comprising data corresponding to said objects;
a set of tables and files characterizing the activation and personalization options of the objects and characterizing the processes, streams and rules associated with the objects;
tools for identifying possible object activations linked to an initial object activation;
management tools for building logic networks comprising data spaces, and preassembled links that can be activated and personalized, each data space may be composed of all the objects, said network being integrated in the single physical database;
a connector object implementing the generic models, the database, the set of tables and files, said identification and management tools;
and said method provides applications:
that are instances of the application management system, one instance representing a specific activation set and a specific personalization set;
which vary over consecutive versions thanks to extensions of said instances based on the application management system, so as to represent software packages;
in which the screens are generated every time the user is prompted via the user interface;
and the application management system as well as the resulting applications operate entirely on a server that can be accessed via an Internet browser.

2. The application management system according to claim 1, wherein an operational entity and/or an organizational entity and/or an analysis tool is suitable for being uniquely referenced while being utilized in several data spaces.

3. The application management system according to claim 2, wherein the referencing is selective according to a set of activation criteria.

4. The application management system according to claim 1, wherein the system comprises means for verifying the consistency in real time between the objects when an object is activated.

5. The application management system according to claim 1, to which wherein an application may utilize several data spaces and conversely a data space may contain several applications.

6. The application management system according to claim 1, comprising a generic device for importing/exporting components of said entities defined by filtering to external data management systems suitable for cooperating with the application management system so as to generate a generic stream that is created with the activation and personalization sets.

7. The application management system according to claim 1, comprising a device for freely parameterizing new components in an entity.

8. The application management system according to claim 1, comprising a common data space, and wherein a data space is suitable for inheriting components from organizational and operational entities of said common data space.

9. The application management system according to claim 1, wherein the common data space itself inherits an initial instance created by default upon launching the connector object.

10. The application management system according to claim 1, comprising an accreditations device comprising:
a plurality of first accreditation levels attributable to an intervening unit of an organizational entity;
a plurality of rights attributable to actions suitable for being performed by an intervening unit;
a plurality of second accreditation levels attributable to at least one user profile with which the intervening units are associated;
said first and second accreditation levels and said plurality of rights being suitable for being combined with each other.

11. The application management system according to claim 10, wherein the accreditation device is suitable for attributing a right to actions associated with a data space, an entity, a component.

12. The application management system according to claim 10, wherein a data space inherits accreditations and rights attributed to the common data space according to a role attributed to an intervening unit of an organizational entity.

13. The application management system according to claim 1, comprising a device for accessibility to components of an operational entity according to a state of progress of the operational entity and a role attributed to an intervening unit of an organizational entity, the state of progress being suitable for being applied to several spaces by respecting the different instances.

14. The application management system according to claim 1, comprising a device to duplicate an original operational entity suitable for using a unit for redefining components of the duplicated operational entity with relation to an original operational entity.

15. The application management system according to claim 1, comprising a rule definition base associated with components of an entity so as to verify the consistency in real time of a screen.

16. The application management system according to claim 1, comprising a hierarchy of levels associated with operational entities in which:
a first-level operational entity is suitable for being directly connected to an organizational entity;
a second-level operational entity is suitable for being directly connected to a first-level operational entity or to an organizational entity; and
a third-level operational entity is suitable for being directly connected to a second-level operational entity or to an organizational entity.

17. The application management system according to claim 16, wherein an operational entity of a level less than the first level is also suitable for being directly connected to another operational entity of the same level, each level of a space may be connected to each level of another space.

18. The application management system according to claim 1, comprising a second device for activating a parameterizable processing procedure according to a type of operational entity.
